(19) United States
(12) Patent Application Publication
(10) Pub. No.: US 2010/0163449 A1
(43) Pub. Date: Jul. 1, 2010

(54) DISPOSABLE BIODEGRADABLE CONTAINERS AND MANUFACTURING METHOD THEREOF

(76) Inventors: Keun Seong Park, Gyeonggi-do (KR); Chris Han, Auckland (NZ)

Correspondence Address: PROSKAUER ROSE LLP, ONE INTERNATIONAL PLACE, BOSTON, MA, 02110, US

(21) Appl. No.: 12/161,117

(22) PCT Filed: Dec. 6, 2007
(86) PCT No.: PCT/KR2007/006313

§ 371 Date: Jul. 16, 2008

(30) Foreign Application Priority Data
Dec. 5, 2007 (KR) 10-2007-0125397

(51) Int. Cl. B65D 85/00; B29C 43/14; B29C 43/02

(52) U.S. Cl. 206/524.6; 264/120

(57) ABSTRACT

A disposable biodegradable container made of a mixture of biodegradable materials to make a disposable container and a method of manufacturing the same are disclosed. The biodegradable material is produced by mixing chaff, saw dust, straw, pulp or a combination thereof with starch, palm fiber, and melamin resin to produce a mixture; pouring the mixture into a mold; and pressurizing the mixture at high temperature and a high pressure at three times. Accordingly, a disposable container having an excellent hardness, elasticity and compact texture can be manufactured by using the biodegradable materials. Also, it is possible to further enhance physical properties of a disposable container by mixing the mixture with esters, polysorbates, stearyl sodium lactates.

### RELATED APPLICATIONS

This application is the U.S. National stage of International Application No. PCT/KR2007/006313, filed on Dec. 6, 2007, in English, which claims priority to Korean Patent Application No. 10-2007-0125397, filed Dec. 5, 2007. The entire teachings of the above applications are incorporated herein by reference.

### FIELD OF THE INVENTION

The present invention relates to a disposable container manufactured by using chaff, saw dust, straw and the like as main ingredients, and more specifically relates to a disposable biodegradable container which is excellent in an elastic force, hardness, water resistance and durability, and which is made of a biodegradable material mixed with palm fiber and melanin resin, and manufacturing method thereof.

### BACKGROUND

Generally, a disposable container is made of wood and is manufactured by being subjected to various chemical treatments including a bleaching treatment, a mold preventing treatment and the like.

These disposable containers made of wood cause various problems as follows.

Since the amount of trees cut down in the forest also increases as the amount of use of the container increases, the forest environment is getting worse; the manufacturing cost of the container is high; various chemical treatments carried out during the manufacturing process are harmful to the human body; incineration of the container causes air pollution; and reclamation of the container causes soil pollution, since various pollutants are released from the container during decomposition of the container. Accordingly, eco-friendly biodegradable materials that can replace the above conventional materials have been developed recently.

### SUMMARY OF THE INVENTION

Eco-friendly biodegradable materials that have been developed until now are materials produced by adding natural materials such as rosin, starch, natural protein, or biodegradable plastic powder to plant raw powder such as chaff, saw dust to improve fluidity or binding properties during compression molding.

However, since the biodegradable material has low binding force with a composition and is weak in moisture, a separate coating treatment with a curing agent or an epoxy resin is necessary. Accordingly, the manufacturing process becomes complicated, and defective containers are manufactured frequently depending on the conditions of heating and pressurizing processes.

Also, much time and cost is required to develop a biodegradable plastic and such development is very difficult. Further, since products commercially available currently are very expensive, they are not suitable for a material of a disposable product.

To solve the problems described above, the applicant of this application developed the invention entitled “Method for manufacturing a disposable biodegradable container”(Korean registered patent 458621; and application date is Apr. 22, 2002).

The registered patent relates to a biodegradable composition produced by adding esters and stearyl sodium lactates that improve a moisturizing effect and provide elasticity, polysorbates that is a dispersant of starch, and rosin that is added to increase a binding force of a composition, to a biodegradable material composition, and a disposable biodegradable container manufactured by compression molding the biodegradable composition in a mold at a high temperature and a high pressure.

The disposable biodegradable container manufactured by the method of the registered patent has compact texture and enhanced hardness compared with a disposable biodegradable container of the prior art since it is molded at a high temperature and a high pressure, but an increase of an elastic force was not sufficient.

Also, the container has some extent of resistance to water when being exposed to water for a short period of time. However, its compact texture has collapsed suddenly and its hardness and elastic force are reduced suddenly, when the container is exposed to water for a given period of time. Consequently, the container has a problem of being broken down too easily.

Accordingly, the present invention has been made to solve the above problems occurring in the prior art, and it is an object of the present invention to provide a biodegradable material produced by mixing chaff, saw dust, straw, pulp or a combination thereof with palm fiber excellent in elastic restoring force, antibacterial properties, breathability and deodorizing properties, and melamin resin having water resistance, heat resistance, adhesive properties, and chemical resistance.

Another object of the present invention is to provide a disposable biodegradable container excellent in elastic force and water resistance and a method for manufacturing the same.

To achieve the above objects, the present invention provides a method for manufacturing a disposable biodegradable container, the method comprising the following steps of:

mixing 52 to 68% by weight of a plant raw powder obtained by grinding a raw material selected from chaff, saw dust, straw, pulp or a combination thereof to a size of 70 to 120 meshes, 8 to 12% by weight of starch, 12 to 18% by weight of palm fiber, 8 to 12% by weight of melamin resin and 4 to 6% by weight of water, to produce a mixture;

pouring the mixture into a mold taking the shape of a container;

primarily pressurizing the mixture poured in the mold at a pressure of 30 to 40 kgf/cm² and a temperature of 150 to 155° C. for 4 to 5 seconds;

secondarily pressurizing the mixture at a pressure of 280 to 320 kgf/cm² for 4 to 5 seconds;

tertiarily pressurizing the mixture at a pressure of 30 to 40 kgf/cm² for 10 to 15 seconds while maintaining a volumetric decreasing rate within a range of 0.75 to 0.85.

Further, the present invention is characterized in that the mixture is produced by mixing 1 to 2 parts by weight of esters, 1 to 2 parts by weight of polysorbates and 1 to 2 parts by weight of stearyl sodium lactates to 100 parts by weight of the mixture.

The method for manufacturing a container of the present invention and the container manufactured by the method have various advantages as follows: the container is not brittle since added palm fiber causes increased elasticity of the container; the period of time that is necessary to carry out the molding step and drying step is shortened since the moisture content is reduced by compression molding carried out at a high temperature and a high pressure; and it is possible to avoid various problems caused by use of a disposable container made of wood. In particular, when the biodegradable container of the present invention is discarded, it is decomposed into harmless soil by decomposition by microorganisms, sunlight, ultraviolet and the like. Also, the container of the present invention can be used as soil improver, and also has necessary elasticity, hardness, stiffness, water tightness, shape sustainability.

Also, a disposable container excellent in elasticity and compact texture can be manufactured by the method for manufacturing a disposable biodegradable container of the present invention.

### BRIEF DESCRIPTION OF THE DRAWINGS

FIG. 1 is a process flow chart of a disposable biodegradable container according to the present invention.

### DETAILED DESCRIPTION

The present invention is described in detail as follows.

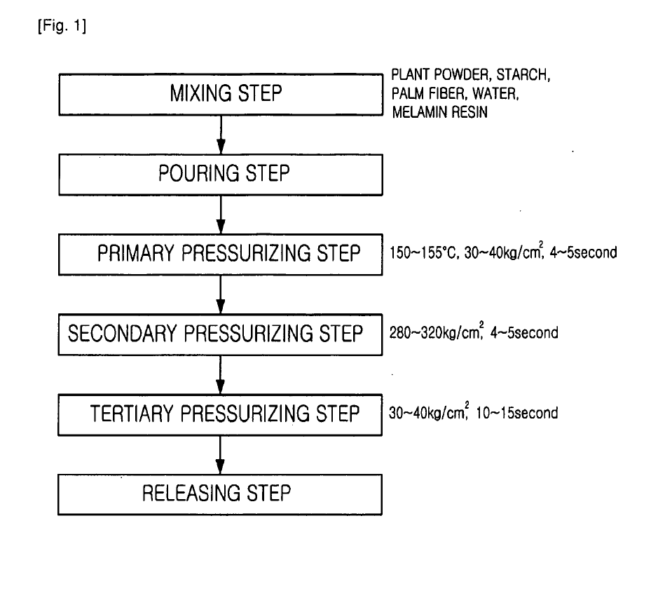

FIG. 1 is a process flow chart of a disposable biodegradable container according to the present invention.

The method for manufacturing a disposable biodegradable container of the present invention includes the steps of: mixing chaff, saw dust, straw, pulp or a combination thereof and starch, palm fiber, water, melamin resin to produce a mixture; pouring the mixture into a mold taking the shape of a container; and tertiarily pressurizing the mixture at a high temperature and a high pressure.

The biodegradable composition of the present invention consists of harmless constituents.

The chaff, saw dust, straw, pulp or a combination thereof is any example of a plant raw material. The plant raw material is not limited to the materials described above. Powders of all annual plants and perennial plants can be used as a plant raw material.

The starch is a starch powder and becomes viscous on mixing with water. Accordingly, the starch serves as a binder binding various mixtures during pressurizing process carried out at a high temperature and a high pressure in the method of the present invention. A potato starch, a sweet potato starch, a corn starch, a crop starch made of barley and rice can be used as starch.

The palm fiber is a fiber extracted from palm fruits that belong to Coco Nuciferu Linn, a member of palm family. Palm fiber itself has 99.9% antibacterial properties and excellent permeability and breathability, and therefore bacteria can not proliferate in the palm fiber. Also, palm fiber emits far infrared of 88.4% and provides a beneficial effect to human, and has a humidity maintaining effect in that it absorbs moisture remaining in the air and discharges moisture on drying. As described above, since palm fiber has various functions including antibacterial properties, breathability, deodorizing properties, warmth retentivity and the like, it has been used in various industrial fields recently.

The palm fiber is a key material of a disposable biodegradable container of the present invention, and prevents the container manufactured by the present invention from breaking easily and enhances elasticity to improve durability of the container.

The palm fiber used in the present invention is a powder of dried stems, leaves and fruits collected from palm.

Further, the melamin resin is colorless and transparent, and has excellent water resistance, heat resistance, adhesive properties and chemical resistance. Accordingly, the melamin resin improves water resistance of the disposable container of the present invention and imparts resistances against heat, acid and solvent to the container.

A mixture is produced by mixing 52 to 68% by weight of a plant raw powder that is a raw material selected from chaff, saw dust, straw, pulp or a combination thereof is grinded to a size of 70 to 120 meshes, 8 to 12% by weight of starch, 12 to 18% by weight of palm fiber, 8 to 12% by weight of melamin resin and 4 to 6% by weight of water.

To improve physical properties of a disposable biodegradable container, esters, polysorbates, and stearyl sodium lactates can be added to the mixture.

The esters promote gelatinization of starches and improve the moisturizing effect to provide elasticity to a container.

The esters are used as a quality improver for noodles, confectionaries or breads, and promote gelatinization of starches and improve the moisturizing effect and workability. Also, the esters function as a defoamer and a releasing agent and impart elasticity to a container to be manufactured.

The stearyl sodium lactates are a hydrophilic emulsifying agent that increase safety and elasticity of wheat gluten and is dispersed in water to uniformize a combination of a binder. The stearyl sodium lactates as esters increase the elasticity of a container.

The polysorbates are a material in which an ethylene oxide is added to sorbitan fatty acid ester to increase hydrophilicity, and has a function to prevent a precipitation of starches as a dispersing agent.

An adding amount of the esters, polysorbates, and stearyl sodium lactates is preferable as follows: 1 to 2 parts by weight of the esters, 1 to 2 parts by weight of the polysorbates and 1 to 2 parts by weight of stearyl sodium lactates based on 100 parts by weight of the mixture respectively.

Also, the disposable biodegradable container further comprises a small amount of a harmless food colorant other than the above mentioned components to color the container beautifully.

As described in FIG. 1, the method for manufacturing a disposable biodegradable container according to the present invention comprises the steps of: mixing each material while matching a compositional ratio to produce a mixture; pouring the mixture into a mold taking the shape of a container; and tertiarily pressurizing the mixture at a high temperature and a high pressure.

The mixing step is performed by mixing 52 to 68% by weight of a plant raw powder obtained by grinding a raw material selected from chaff, saw dust, straw, pulp or a combination thereof to a size of 70 to 120 meshes, 8 to 12% by weight of starch, 12 to 18% by weight of palm fiber, 8 to 12% by weight of melamin resin and 4 to 6% by weight of water, to produce a mixture.

When the particle size of the plant raw powder is smaller than 120 meshes, the plant raw powder can be released during the use of a container after the container has been manufactured, and when the particle size thereof is larger than 70 meshes, a strength of the container is decreased due to reduction of a binding force of the mixture during the manufacture of the container. Accordingly, the particle size of a plant raw powder is preferable within a range from 120 to 70 meshes.

As the palm fiber, a stem, a leaf or a fruit of palm can be used, however a stem of palm is the most preferable since its antibacterial properties, breathability and deodorizing properties are excellent.

Also, the palm fiber is preferable to grind to a size of 70 to 120 meshes in case of considering mixing with other materials.

The pouring step is performed by pouring a mixture mixed in a mixing step into a mold. Before the pouring, when a mold is preheated, it is possible to expedite the processing.

The pressurizing step is carried out at three times. In the tertiary pressurizing step, a mixture poured in a mold is pressurized at a temperature of 150 to 155° C. and a pressure of 30 to 40 kgf/cm² for 4 to 5 seconds.

After the primary pressurizing step, a compression molding step consisting of the secondary pressurizing step at a pressure of 280 to 320 kgf/cm² for 4 to 5 seconds and the tertiary pressurizing step at a pressure of 30 to 40 kgf/cm² for 10 to 15 seconds are carried out, while a volumetric decreasing rate is maintained within a range of 0.75 to 0.85.

In the pressurizing step, a volumetric decreasing rate is preferably to maintain within a range of 0.75 to 0.85. When compressibility is too high, a container is broken easily since the texture is not compact. Also, when compressibility is too low, a container is too brittle since elasticity is not sufficient.

A volumetric decreasing rate is obtained by subtracting volume after compression (V2) from volume before compression (V1) to obtain a value and dividing the value by V1. That is, the equation is as follows: (V1−V2)/V1

Since the disposable biodegradable container according to the present invention is manufactured by compression molding at high temperature of 150 to 155° C. and high pressure of 280 to 320 kgf/cm², thereby a volumetric decreasing rate is maintained within a range of 0.75 to 0.85, it is possible to obtain a disposable biodegradable container having sufficient hardness and elasticity due to such high density molding. Also, since a molding temperature is 150° C. or more, it is not necessary to carry out a separate sterilization process.

Since compression molding of a mixture of a plant raw powder and melamin resin, a binder of starch, and palm fiber at high temperature and high pressure is carried out in the method for manufacturing a disposable biodegradable container according to the present invention, it is possible to obtain a disposable biodegradable container having an excellent safety and quality due to antibacterial properties, breathability, deodorizing properties and warmth retentivity of palm fiber and having non-brittleness due to elastic restoring force of palm fiber.

Also, since durability and water resistance are improved due to use of melamin resin, a coating process or other process to improve water resistance is not necessary.

It will be understood that the present invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying claims

1. A method for manufacturing a disposable biodegradable container, comprising:
mixing 52 to 68% by weight of a plant raw powder obtained by grinding a raw material selected from chaff, saw dust, straw, pulp or a combination thereof to a size of 70 to 120 meshes, 8 to 12% by weight of starch, 12 to 18% by weight of palm fiber, 8 to 12% by weight of melamin resin and 4 to 6% by weight of water, to produce a mixture;
pouring the mixture into a mold having a shape of a container;
primarily pressurizing the mixture poured in the mold at a pressure of 30 to 40 kgf/cm² and a temperature of 150 to 155° C. for 4 to 5 seconds;
secondarily pressurizing the mixture at a pressure of 280 to 320 kgf/cm² for 4 to 5 seconds;
tertiarily pressurizing the mixture at a pressure of 30 to 40 kgf/cm² for 10 to 15 seconds while maintaining a volumetric decreasing rate within a range of 0.75 to 0.85.

2. The method according to claim 1, further comprising mixing 1 to 2 parts by weight of esters, 1 to 2 parts by weight of polysorbates and 1 to 2 parts by weight of stearyl sodium lactates to 100 parts by weight of the mixture.

3. A disposable biodegradable container manufactured by the method according to claim 1.

4. A disposable biodegradable container manufactured by the method according to claim 2.

5. A method for manufacturing a disposable biodegradable container, comprising:
mixing a biodegradable composition that comprises a plant raw powder, starch, melamin resin, water and palm fiber to produce a mixture;
pouring the mixture into a container-shaped mold;
pressurizing the mixture in the mold at a first pressure and temperature to produce the disposable biodegradable container.

6. The method according to claim 1, further comprising
adding esters, polysorbates and stearyl sodium lactates to the mixture.

7. A disposable biodegradable container manufactured by the method according to claim 5.

8. A disposable biodegradable container manufactured by the method according to claim 6.
